(19) United States
(12) Patent Application Publication
(10) Pub. No.: US 2015/0245214 A1
(43) Pub. Date: Aug. 27, 2015

(54) ENHANCED POLLING FOR SECURITY MODE PROCEDURES

(71) Applicant: QUALCOMM Incorporated, San Diego, CA (US)

(72) Inventors: Krishna Chaitanya Bellam, Hyderabad (IN); Sitaramanjaneyulu Kanamarlapudi, San Diego, CA (US); Liangchi Hsu, San Diego, CA (US)

(21) Appl. No.: 14/463,348

(22) Filed: Aug. 19, 2014

Related U.S. Application Data
(60) Provisional application No. 61/943,187, filed on Feb. 21, 2014.

(51) Int. Cl. H04W 12/08; H04W 76/04

(52) U.S. Cl. CPC H04W 12/08; H04W 76/045

(57) ABSTRACT

The present disclosure provides for performing security mode procedures. A user equipment (UE) may receive a security mode command from a network such as a UTRAN. The UE may process the security mode command at the radio resource control layer to update security information such as ciphering information. The UE may generate a security mode complete message informing the network when to begin using the updated security information. The UE may generate at least one radio link control layer PDU from the security mode complete message. The UE may set a polling bit of a last PDU. The polling bit may cause the network to acknowledge the security mode complete message with status information. During the update, the UE may suspend one or more radio bearers used by the UE. The UE may resume the suspended radio bearers using the new security information in response to receiving the status information.

### CROSS-REFERENCE TO RELATED APPLICATIONS

The present Application for patent claims priority to U.S. Provisional Patent Application No. 61/943,187, “ENHANCED POLLING FOR SECURITY MODE PROCEDURES” filed Feb. 21, 2014, and assigned to the assignee hereof and hereby expressly incorporated by reference herein in its entirety.

### BACKGROUND

Aspects of the present disclosure relate generally to wireless communication systems, and more particularly, to security mode procedures.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Wireless communication networks may employ security procedures to ensure integrity and/or secrecy of communications. A wireless network may update security parameters such as ciphering information during security procedures. A wireless device may suspend transmitting and receiving on various radio bearers during a security mode update. The wireless device may drop calls if the radio bearers remain suspended.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides for performing security mode procedures. A user equipment (UE) may receive a security mode command from a network such as a UTRAN. The UE may process the security mode command at the radio resource control layer to update security information such as ciphering information. The UE may generate a security mode complete message informing the network when to begin using the updated or new security information. The UE may generate at least one radio link control layer PDU from the security mode complete message. The UE may set a polling bit of a last PDU of the at least one PDU. The polling bit may cause the network to acknowledge the security mode complete message with status information. During the update, the UE may suspend one or more radio bearers used by the UE. The UE may resume the suspended radio bearers using the updated or new security information in response to receiving the status information.

In one aspect, the disclosure provides a method of providing secure communication. The method includes receiving a security mode command. The method further includes generating a security mode complete message in response to receiving the security mode command. The method may also include generating at least one PDU from the security mode complete message and setting, at a user equipment, a polling bit of a last PDU of the at least one PDU regardless of a polling configuration provided by a network.

Another aspect of the disclosure provides an apparatus for providing secure communication. The apparatus includes: means for receiving a security mode command; means for generating security mode complete message as a plurality of protocol data units (PDUs) in response to receiving the security mode command; means for generating at least one protocol data unit (PDU) from the security mode complete message; and means for setting, by the apparatus, a polling bit of a last PDU of the at least one PDU regardless of a polling configuration provided by a network.

In another aspect, the disclosure provides a non-transitory computer-readable medium storing computer executable code. The non-transitory computer readable medium includes code for: receiving a security mode command; generating a security mode complete message in response to receiving the security mode command; generating at least one PDU from the security mode command; and setting, by a user equipment, a polling bit of a last PDU of the at least one PDU regardless of a polling configuration provided by a network.

Yet another aspect of the disclosure provides another apparatus for providing secure communication, including: a receiver configured to receive a security mode command; a ciphering component configured to generate a security mode complete message in response to receiving the security mode command; a PDU generator configured to generate at least one PDU from the security mode command; and a polling controller configured to set, at the apparatus, a polling bit of a last PDU of the at least one PDU regardless of a polling configuration provided by a network.

These and other aspects of the invention will become more fully understood upon a review of the detailed description, which follows.

### BRIEF DESCRIPTION OF THE DRAWINGS

FIG. 1 is a schematic diagram of a communication network including an aspect of user equipment that may perform security mode procedures.

FIG. 2 is a flowchart of an aspect of a method of performing security mode procedures.

FIG. 3 is a message diagram illustrating security mode procedures.

FIG. 4 is a block diagram illustrating an example of a hardware implementation for an apparatus employing a processing system.

FIG. 5 is a block diagram illustrating an example of a telecommunications system.

FIG. 6 is a diagram illustrating an example of an access network.

FIG. 7 is a diagram illustrating an example of a radio protocol architecture for the user and control plane.

FIG. 8 is a block diagram illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides methods and apparatuses for performing security mode procedures. For example, a wireless device such as a user equipment (UE) may receive a security mode command from a network such as a UTRAN. The UE may process the security mode command at the radio resource control layer to update security information such as ciphering information. During the update, the UE may suspend one or more radio bearers used by the UE. The UE may then transmit a security mode complete message informing the network when to begin using the new security information. If the UE does not receive confirmation that the security mode complete message has been received, the UE may be unable to resume the suspended bearers, and the UE may drop a call. The UE may force acknowledgement of the security mode complete message by setting a polling bit of a last protocol data unit (PDU) associated with the security mode complete message. The last PDU associated with the security mode complete message may be a PDU including a last segment of the security mode complete message. The sequence number of the last PDU may be greater than the sequence number of other PDUs including segments of the security mode complete message. In an aspect, the last PDU associated with the security mode complete message may be the last PDU before a signaling radio bearer is suspended. The polling bit may cause the network to acknowledge the security mode complete message with status information. The UE may then resume the suspended radio bearers using the new security information.

According to an aspect, the radio link control (RLC) layer at the UE may always set the polling bit in the last PDU of a security mode complete message. Setting the polling bit may ensure that the UE receives acknowledgement of the security mode complete message in an adequate time to resume suspended radio bearers. As such, according to an aspect, the disclosed methods and apparatuses may improve user experience by reducing occurrence of dropped calls.

Although the term “protocol data unit (PDU)” may refer to the output of any protocol, as used herein, unless modified, the term PDU refers to an RLC layer PDU. Likewise, the term “service data unit (SDU),” unless modified, refers to a RLC SDU. For example, the RRC layer may generate a security mode complete message (RRC PDU/RLC SDU), which may be referred to simply as an SDU. The RLC layer may generate a plurality of RLC PDUs from the SDU. The RLC PDUs may be referred to simply as PDUs.

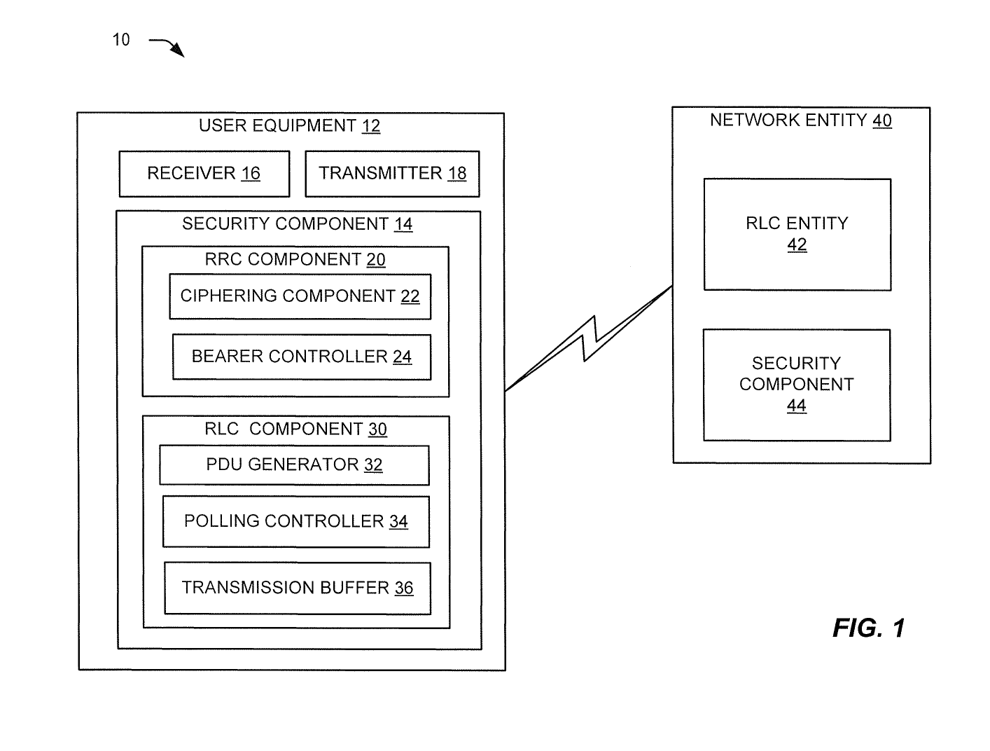

Referring to FIG. 1, in an aspect, a wireless communication system 10 includes at least one UE 12 in communication coverage of at least one network entity 40 (e.g., base station or radio network controller (RNC)). In an aspect, the network entity 40 may be a base station such an eNodeB in an LTE network. In another aspect, the network entity 40 may be a RNC in a UTRAN network. UE 12 may communicate with a network via network entity 40. In some aspects, multiple UEs including UE 12 may be in communication coverage with one or more network entities, including network entity 40. In an example, UE 12 may transmit and/or receive wireless communications to and/or from network entity 40. Such wireless communications may be inherently unreliable to some extent. The wireless communication system 10 may use a radio link control (RLC) protocol to improve reliability of communications. The present aspects provide a UE-side approach to security mode procedures at the RRC and RLC layers to improve reliability of security mode messages.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. Additionally, network entity 40 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, the UE 12 may include a security component 14 configured to perform security mode procedures with a network entity 40. For example, security component 14 may be configured to receive a security mode command, suspend radio bearers, update security information, send a security mode complete message, and resume the suspended bearers using the updated security information. In an aspect, the term “component” as used herein may be one of the parts that make up a system, may be hardware, firmware, and/or software, and may be divided into other components. The security component 14 may include a radio resource control (RRC) component 20 and a radio link control (RLC) component 30. The UE 12 may also include a receiver 16 and transmitter 18 for providing wireless communications.

The receiver 16 may be configured to receive radio signals from an antenna. For example, the receiver 16 may include a radio receiver and receive chain components and/or modules. The receiver 16 may receive radio frequency (RF) analog signals and sample the signals to provide digital samples. The RF signals may carry a security mode command. The transmitter 18 may be configured to transmit radio signals from an antenna. The transmitter 18 may include a radio transmitter and transmit chain components and/or modules. The transmitter 18 may transmit radio signals carrying a security mode complete message. In an aspect, the receiver 16 and the transmitter 18 may be integrated into a single component or module, which may be referred to as a transceiver.

The RRC component 20 may be configured to control communications according to a radio resource control protocol. The RRC protocol may be described in further detail, for example, in 3GPP TS 25.331 v.12.0.0, which is hereby incorporated herein by reference in its entirety. In particular, the RRC component 20 may be configured to perform security mode procedures. The RRC component 20 may include a ciphering component 22 and a bearer controller 24. The RRC component 20 may be further configured to use the RLC component 30 to send and receive messages.

The ciphering component 22 may be configured to update security configuration information including ciphering information and integrity protection information when the UE 12 receives a security mode command. The ciphering component 22 may update the security configuration information based on the contents of the security mode command.

The ciphering component 22 may also determine an RLC sequence number at which time the updated security information will be applied. The RLC sequence number may indicate the first PDU to which the updated security configuration is applied. In an aspect, the sequence number may be based on a number of protocol data units (PDU) in an RLC transmission buffer 36 and a number of PDUs necessary to transmit a security mode complete message. For example, the sequence number may be equal to the most recently transmitted PDU sequence number plus the length of the transmission buffer 36 plus the length of a security mode complete message plus a minimal delay. The ciphering component 22 may generate a security mode complete message including the RLC sequence number for which the updated security information is to be applied.

The bearer controller 24 may control one or more radio bearers according to a security configuration. The bearer controller 24 may use the security configuration information for communications using the radio bearers. During security mode update procedures, the bearer controller 24 may suspend one or more of the bearers. The bearer controller 24 may suspend all radio bearers except a signaling bearer used to communicate the security mode complete message. The bearer controller 24 may wait until confirmation that the security mode complete message has been received by the network before resuming the suspended bearers using the new security configuration information. For example, the bearer controller 24 may wait until the RLC component 30 has received status information from the network entity 40 acknowledging that the security mode complete message has been received.

RLC component 30 may be configured to control communications according to a radio link control (RLC) protocol. The RLC protocol may be described in further detail in, for example, 3GPP TS 25.322. v.11.2.0, which is hereby incorporated herein by reference in its entirety. Generally, the RLC component 30 may segment higher layer messages into a plurality of variable length PDUs for transmission over a radio link. The RLC component 30 may also reassemble received PDUs into higher layer messages. The RLC component 30 may include a PDU generator 32, a polling controller 34, and a transmission buffer 36.

The PDU generator 32 may be configured to generate a plurality of PDUs based on a higher layer message. For example, PDU generator 32 may generate a plurality of PDUs based on a security mode complete message generated by RRC component 20. Each PDU may include a header including information allowing the message to be reassembled at a receiving node. The header information may also include a polling bit. The header may also include a, data/control (D/C) field, sequence number, header extension type field (HE), length indicator, and extension bit. In an aspect, the security mode complete message may fit within a single PDU, in which case the single PDU may be the last PDU.

Polling controller 34 may control the status of the polling bit of each PDU. Setting the polling bit may indicate that the receiving node should acknowledge the receipt of one or more PDUs by sending status information. Polling controller 34 may be configured to process such status information and report the status of messages to higher layers. Such acknowledgement consumes network resources and therefore imposes a cost. The polling controller 34 may generally be configured to control the polling bits according to a polling configuration provided by the network 40. For example, the network 40 may provide polling triggers indicating specific conditions under which the polling bit should be set. For example, the polling triggers may indicate when the polling bit should be set based on designated times, numbers of transmitted PDUs or SDUs, and the status of transmission buffer 36. For example, a polling trigger may indicate that the polling bit should be set every 100 PDUs. The polling triggers may also impose limits on how often the polling bit should be set. For example, a Poll Prohibit function may establish a timer and prohibit the polling controller 34 from setting the polling bit until the timer has expired.

Polling controller 34 may also be configured to set the polling bit for particular higher level messages such as a security mode complete message. In particular, the polling controller 34 may be configured to set the polling bit of the last PDU of a security mode complete message. Polling controller 34 may set the polling bit of the last PDU of a security mode complete message regardless of configured polling triggers. For example, polling controller 34 may set the polling bit even if the polling configuration includes a minimum time between polls that has not been satisfied. The polling controller 34 may also set a polling bit for any PDU transmitted after the security mode complete message before the signaling radio bearer is suspended. For example, the polling controller 34 may set a polling bit of a last PDU of a measurement report transmitted after the security mode complete message.

Transmission buffer 36 may be a buffer configured to store PDUs waiting for transmission. Transmission buffer 36 may include a plurality of transmission buffers corresponding to radio bearers. Transmission buffer 36 may also include a retransmission buffer configured to store PDUs that should be retransmitted because receipt of the PDUs has not been acknowledged.

Network entity 40 may be a network node, such as, for example, a base station, Node B, eNodeB, or RNC communicating with UE 12 via a radio link. The network entity 40 may include an RLC entity 42 and a security component 44. The RLC entity 42 may be configured to control communications according to the RLC protocol. In particular RLC entity 42 may be configured to provide status update information when network entity 40 receives a PDU with the polling bit set. Security component 44 may provide a security mode command including updated security configuration information.

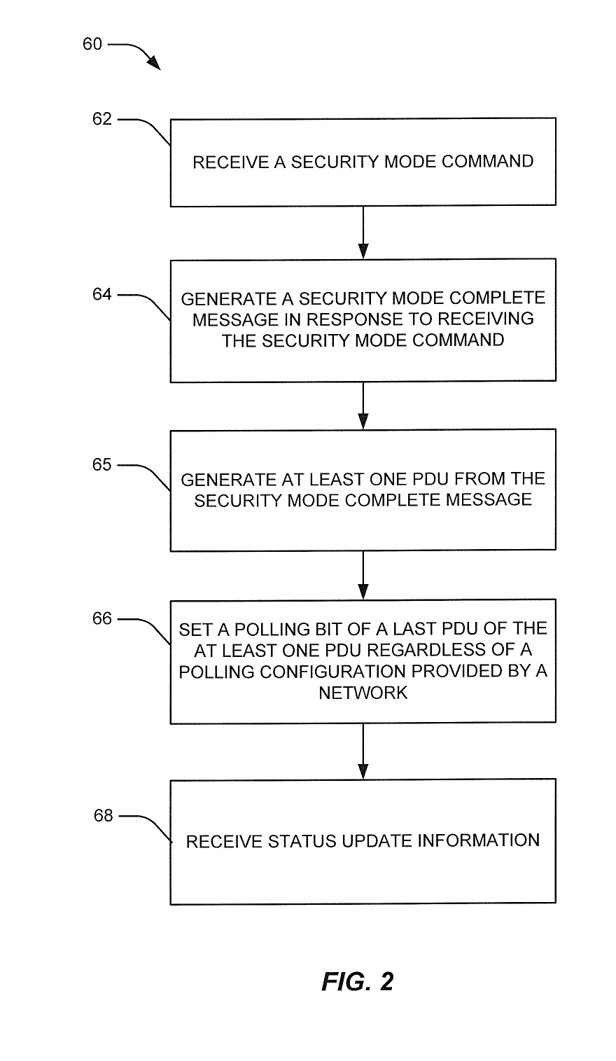

Referring to FIG. 2, in an operational aspect, a UE such as UE 12 (FIG. 1) may perform one aspect of a method 60 for security mode procedures. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 62, method 60 includes receiving a security mode command. For example, the receiver 16 may receive the security mode command from the network entity 40. The security mode command may include security configuration information that should be used by the UE 12 after an activation time. The RRC component 20 may suspend radio bearers in response to receiving the security mode command. The UE 12 may leave one signaling radio bearer (SRB) active, SRB2 for example, to allow completion of the security mode update procedure.

At block 64, the method 60 includes generating a security mode complete message in response to receiving the security mode command. In an aspect, for example, the ciphering component 22 may generate the security mode complete message in response to receiving the security mode command. The security mode complete message may indicate that the UE 12 has updated security configuration information according to the security mode command. The ciphering component 22 may determine a sequence number when the updated security configuration information will become effective. The sequence number may be based on a number of PDUs ready to send and a number of PDUs in the security mode complete message. The security mode complete message may include the sequence number identifying an RLC PDU where the updated security configuration information will become effective.

In an aspect, at block 65, the method 60 may include generating at least one PDU from the security mode complete message. For example, the PDU generator 32 may generate at least one PDU from the security mode complete message. The PDU generator 32 may receive a security mode complete message SDU from the RRC component 20, and segment the SDU into a plurality of PDUs. The PDU generator 32 may also add an RLC header to each PDU.

At block 66, the method 60 may include setting the polling bit of the last protocol data unit of the at least one PDU regardless of a polling configuration provided by a network. In an aspect, for example, the polling controller 34 may set the polling bit of the last PDU of the at least one PDU regardless of a polling configuration provided by a network. The polling controller 34 may set the polling bit in the RLC header of the PDU to TRUE indicating that the receiving network node should acknowledge receipt of the PDU by sending status update information. The polling controller 34 may set the polling bit regardless of any polling configuration provided by the network entity 40. For example, the polling controller 34 may set the polling bit even though no polling trigger provided by the network has been satisfied. As another example, the polling controller 34 may set the polling bit even though a poll prohibit function is active. The polling controller 34 may set the polling bit when a poll prohibit timer is running. The UE 12 may transmit the plurality of PDUs including the last PDU having the polling bit set. The network may respond by sending the status update information.

In block 68, the method 60 may include receiving the status update information. In an aspect, for example, the receiver 16 may receive the status update information. The status update information may confirm to the UE 12 that the security mode complete message has been received. For example, the status information may acknowledge receipt of each of the plurality of PDUs. In an aspect, the status update information may indicate whether a PDU is missing. The UE 12 may retransmit any missing PDUs. For example, the UE 12 may retransmit one or more of the plurality of PDUs when the status information indicates that the one or more of the plurality of PDUs was not received. The UE 12 may then resume any suspended bearers and use the updated security configuration information.

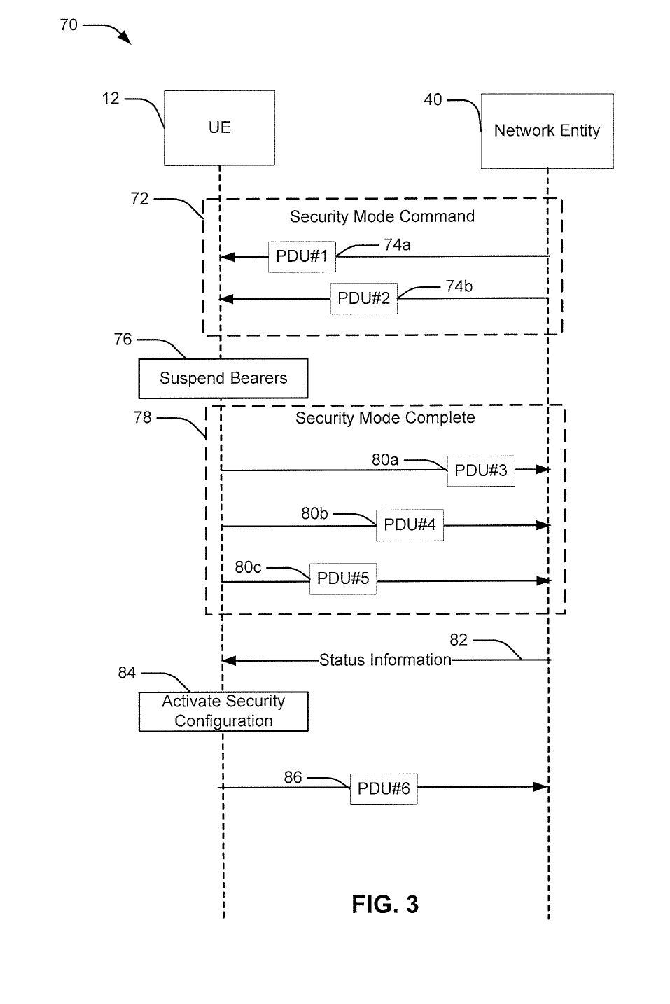

FIG. 3 is a message diagram 70 illustrating security mode procedures. The UE 21 may receive a security mode command 72. The security mode command 72 may include one or more PDUs, for example PDU 74a and PDU 74b. The RLC component 30 may reassemble the security mode command 72 from the PDUs 74 and pass the security mode command 72 to the RRC component 20. At block 76, the RRC component 20 may suspend the radio bearers. The RRC component 20 may also generate the security mode complete message 78. The RLC component 30 may segment the security mode complete message 78 into a plurality of PDUs 80. For example, the plurality of PDUs 80 may include PDU 80a, PDU 80b, and PDU 80c. PDU 80c may be a last PDU of the plurality of PDUs 80, which are associated with the security mode complete message 78. The polling controller 34 may set the polling bit of the last PDU 80c. When the network entity 40 receives the last PDU 80c, the RLC entity 42 may determine whether the PDUs 80 have been received and generate status information 82. If the status information 82 indicates that the PDUs 80 have all been received, the RLC component 30 may provide the RRC component 20 with acknowledgment that the security mode complete message was received. At block 84, the RRC component 20 may activate the new security information and resume the suspended bearers. RLC entity 30 may then generate additional PDUs, for example PDU 86 for transmission using the new security configuration. In an aspect, PDU 86 may have a sequence number computed as the activation time for the new security configuration. Network entity 40 may process PDU 86 using the new security configuration.

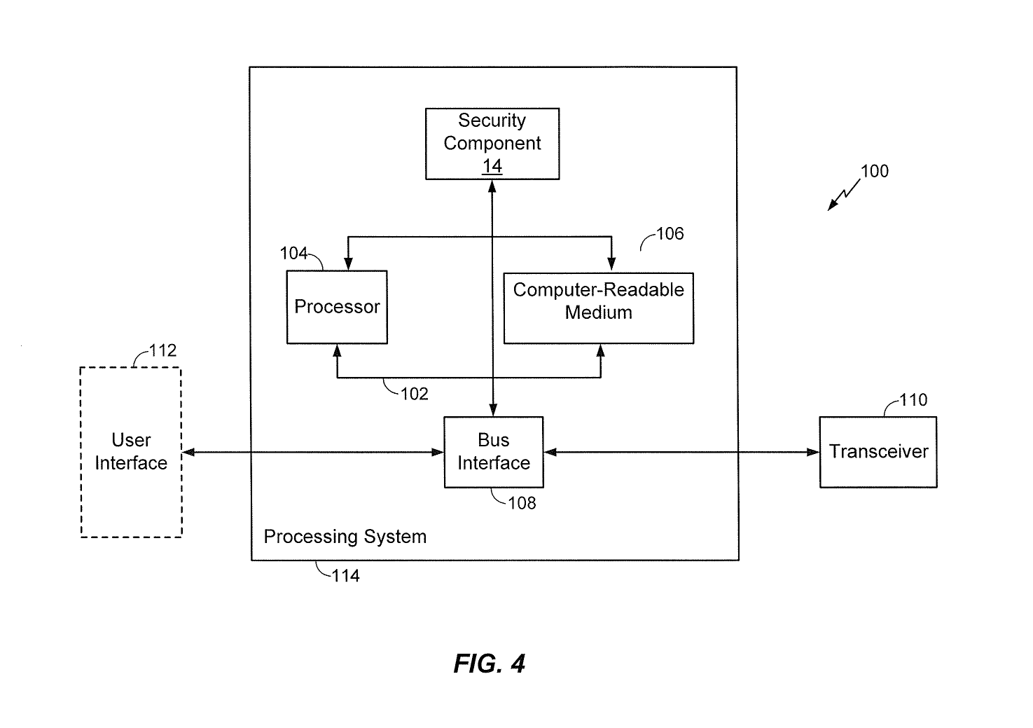

FIG. 4 is a block diagram illustrating an example of a hardware implementation for an apparatus 100 employing a processing system 114 including a security component 14. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

The security component 14 may include hardware configured for performing security mode operations in the apparatus 100. The security component 14 may be a separate component, or may be integrated with the processor 104 or the computer-readable medium 106. The security component 14 may control transceiver 110 for receiving a security mode command and sending a security mode complete message. The security component 14 may update security configuration information, which may be stored in the computer-readable medium 106 and used by the processor 104.

Further, security component 14 (FIG. 1) may be implemented by any one or more of processor 104 and computer-readable medium 106. For example, the processor and/or computer-readable medium 106 may be configured to, via security component 14, perform security mode operations for a wireless communications device (e.g., UE 12). Accordingly, the security component 14 may be implemented as hardware, software, firmware, etc.

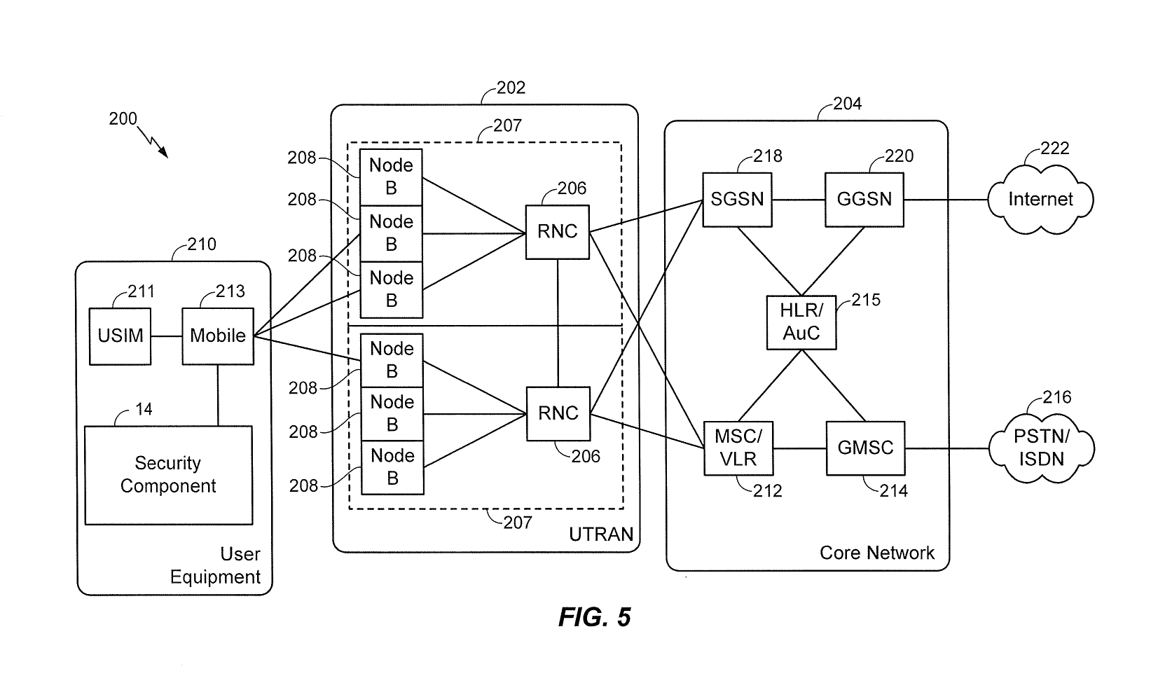

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. The UE 210 may correspond to the UE 12 and include a security component 14 for performing security mode procedures. The UE 210 may further include mobile equipment 213 for performing wireless communications. The mobile equipment 213 may include the security component 14.

In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information herein utilizes terminology introduced in the RRC Protocol Specification.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the channel quality indicator (CQI) and precoding matrix indicator (PMI).

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

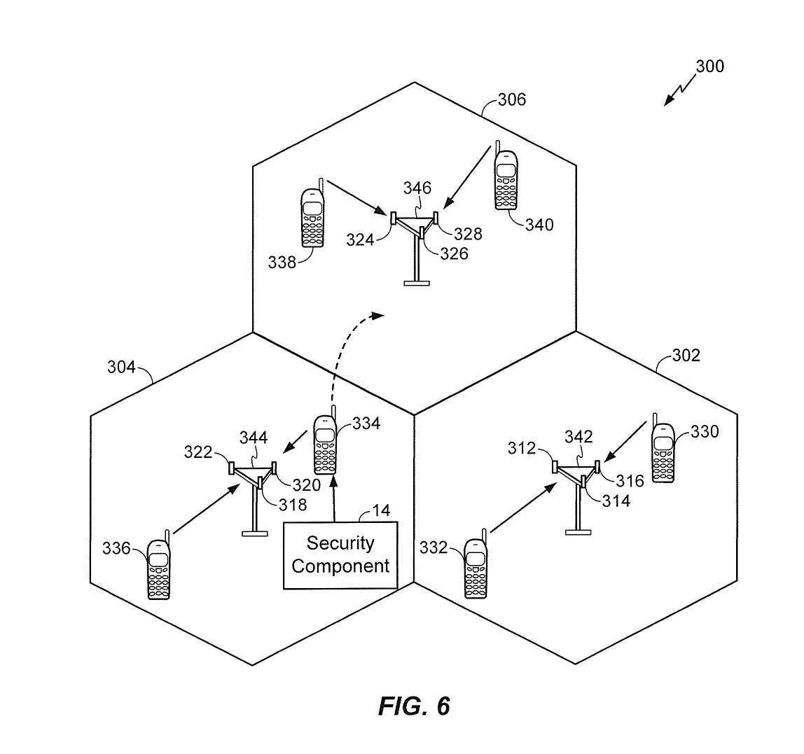

Referring to FIG. 6, an access network 300 in a UTRAN architecture is illustrated. The multiple access wireless communication system includes multiple cellular regions (cells), including cells 302, 304, and 306, each of which may include one or more sectors. The UEs 330, 332, 334, 336, 338, 340 may each correspond to the UE 12 (FIG. 1) and include a security component 14. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 2) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 2), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

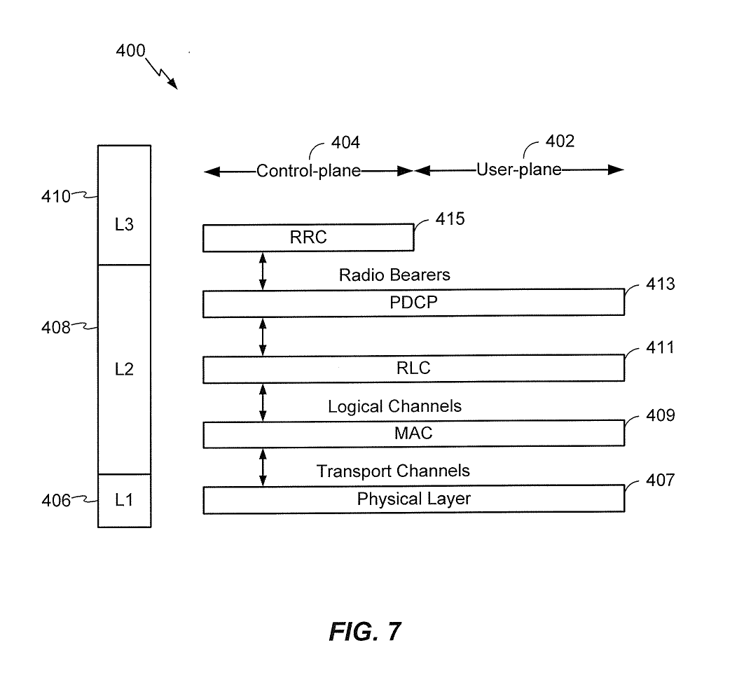

The radio protocol architecture may take on various forms depending on the particular application. An example for an HSPA system will now be presented with reference to FIG. 7.

Referring to FIG. 7, an example radio protocol architecture 400 relates to the user plane 402 and the control plane 404 of a user equipment (UE) or node B/base station. For example, architecture 400 may be included in a UE such as wireless device 12 (FIG. 1). The radio protocol architecture 400 for the UE and node B is shown with three layers: Layer 1 406, Layer 2 408, and Layer 3 410. Layer 1 406 is the lowest layer and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The RLC sublayer 411 may be controlled by RLC component 30 (FIG. 1) to provide polling for security mode complete messages. The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

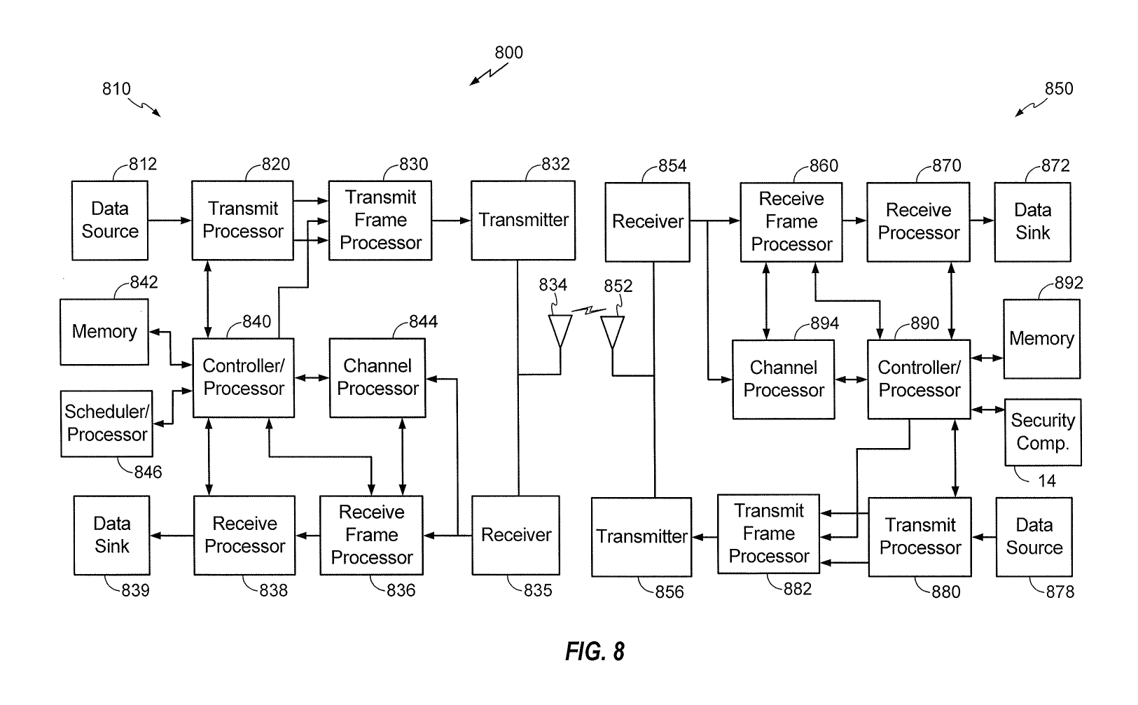

FIG. 8 is a block diagram of a Node B 710 in communication with a UE 750, where the Node B 710 may be the network entity 40 in FIG. 1 or Node B 208 in FIG. 3, and the UE 750 may be the UE 12 in FIG. 1 or the UE 210 in FIG. 3. In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames. The security component 14 may perform deciphering and integrity checks on the decoded frames. The security component 14 may also perform security mode procedures including updating security configurations, suspending radio bearers, transmitting a security mode complete message having a polling bit set, and resuming radio bearers using new security configurations.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of providing secure communication comprising:
receiving a security mode command;
generating a security mode complete message in response to receiving the security mode command;
generating at least one protocol data unit (PDU) from the security mode complete message; and
setting, at a user equipment, a polling bit of a last PDU of the at least one PDU regardless of a polling configuration provided by a network.

2. The method of claim 1, further comprising:
transmitting the at least one PDU on a signaling radio bearer.

3. The method of claim 2, further comprising:
suspending a radio bearer in response to receiving the security mode command;
receiving status information acknowledging receipt of the at least one PDU; and
resuming the suspended radio bearer based on the status information.

4. The method of claim 3, further comprising retransmitting a PDU of the at least one PDU when the status information indicates that the PDU of the at least one PDU was not received.

5. The method of claim 3, further comprising transmitting a PDU other than the at least one PDU on the signaling radio bearer after transmitting the at least one PDU and before receiving the status information.

6. The method of claim 5, further comprising setting the polling bit of the PDU other than the at least one PDU.

7. The method of claim 1, further comprising:
updating ciphering information based on receiving the security mode command; and
determining a sequence number when the updated ciphering information will become effective, wherein the security mode complete message includes the sequence number.

8. The method of claim 7, wherein determining the sequence number is based on a number of PDUs ready to send and a number of PDUs in the at least one PDU.

9. The method of claim 1, wherein setting a polling bit of a last PDU of the at least one PDU regardless of any polling configuration provided by the network includes setting the polling bit when no polling trigger of the polling configuration has been satisfied.

10. The method of claim 1, wherein setting the polling bit of the last PDU of the at least one PDU regardless of any polling configuration provided by a network comprises setting the polling bit when the polling configuration prohibits setting the polling bit.

11. An apparatus for providing secure communication, comprising:
means for receiving a security mode command;
means for generating security mode complete message based on receiving the security mode command;
generating at least one protocol data unit (PDU) from the security mode complete message; and
means for setting, by the apparatus, a polling bit of a last PDU of at least one PDU regardless of a polling configuration provided by a network.

12. The apparatus of claim 11, further comprising:
means for transmitting the at least one PDU on a signaling radio bearer.

13. The apparatus of claim 12, further comprising:
means for suspending a radio bearer responsive to receiving the security mode command;
means for receiving status information acknowledging receipt of the last PDU; and
means for resuming the suspended radio bearer based on receiving the status information.

14. The apparatus of claim 13, further comprising: means for retransmitting a missing PDU of the at least one PDU when the status information indicates that the missing PDU was not received.

15. The apparatus of claim 13, further comprising means for transmitting a PDU other than the at least one PDU of the security mode complete message on the signaling radio bearer after transmitting the at least one PDU and before receiving the status information, wherein a polling bit of the PDU is set.

16. The apparatus of claim 11, further comprising:
means for updating ciphering information responsive to receiving the security mode command; and
means for determining a sequence number when the updated ciphering information will become effective, wherein the security mode complete message includes the sequence number.

17. The apparatus of claim 16, wherein the sequence number is based on a number of PDUs ready to send and a number of PDUs in the at least one PDU.

18. The apparatus of claim 11, wherein the means for setting is configured to set the polling bit when no polling trigger of the polling configuration has been satisfied.

19. The apparatus of claim 11, wherein the means for setting is configured to set the polling bit when the polling configuration prohibits setting the polling bit.

20. An apparatus for providing secure communication, comprising:
a receiver configured to receive a security mode command;
a ciphering component configured to generate a security mode complete message based on receiving the security mode command;
a protocol data unit (PDU) generator configured to generate at least one PDU from the security mode command; and
a polling controller configured to set, at the apparatus, a polling bit of a last PDU of the at least one PDU regardless of a polling configuration provided by a network.

21. The apparatus of claim 20, further comprising a transmitter configured to transmit the at least one PDU on a signaling radio bearer.

22. The apparatus of claim 21, further comprising:
a bearer controller configured to suspending a radio bearer based on receiving the security mode command and resume the suspended radio bearer based on the receiver receiving status information acknowledging receipt of the at least one PDU.

23. The apparatus of claim 22, wherein the transmitter is further configured to retransmit a missing PDU of the at least one PDU when the status information indicates that the missing PDU was not received.

24. The apparatus of claim 22, wherein the transmitter is further configured to transmit a PDU other than the at least one PDU on the signaling radio bearer after transmitting the at least one PDU and before the receiver receives the status information.

25. The apparatus of claim 24, wherein the polling controller is further configured to set the polling bit of the PDU other than the at least one PDU.

26. The apparatus of claim 20, wherein the ciphering component is further configured to update ciphering information in response to receiving the security mode command; and determine a sequence number when the updated ciphering information will become effective, wherein the security mode complete message includes the sequence number.

27. The apparatus of claim 26, further comprising a transmission buffer, wherein the ciphering component determines the sequence number based on a number of PDUs in the transmission buffer and a number of PDUs in the at least one PDU.

28. The apparatus of claim 20, wherein the polling controller is configured to set the polling bit when no polling trigger of the polling configuration has been satisfied.

29. The apparatus of claim 20, wherein the polling controller is configured to set the polling bit when the polling configuration prohibits setting the polling bit.

30. A computer-readable medium storing computer executable code, comprising code for:
receiving a security mode command;
generating a security mode complete message based on receiving the security mode command;
generating at least one PDU from the security mode command; and
setting, by a user equipment, a polling bit of a last PDU of the at least one PDU regardless of a polling configuration provided by a network.
